(19) United States
(12) Patent Application Publication
(10) Pub. No.: US 2020/0187615 A1
(43) Pub. Date: Jun. 18, 2020

(54) MULTI-FUNCTIONAL ELECTRIC COOLER

(71) Applicant: Reginald Lee Hockaday, JR., Silver Spring, MD (US)

(72) Inventor: Reginald Lee Hockaday, JR., Silver Spring, MD (US)

(21) Appl. No.: 16/221,513

(22) Filed: Dec. 15, 2018

(51) Int. Cl. A45C 11/20; H04R 1/02; F25B 27/00; A45C 13/26

(52) U.S. Cl. CPC A45C 11/20; H04R 1/028; F25B 27/002; F25D 2400/12; H04R 2420/07; H04R 2420/09; A45C 13/262

(57) ABSTRACT

A multi-functional electric cooler having an electric motor, a control arm including a handlebar member for controlling braking and acceleration of the cooler, the handlebar member having a built-in grip mechanism wherein the speed of the cooler is adjusted based on the grip intensity of the handlebar member, a plurality of wheels for transporting the cooler, wherein the wheels are spherical wheels, a housing unit having an enclosed insulated container for providing a temperature controlled storage area, a lid member including a plurality of cup holders and a solar panel for providing power to the cooler, wherein the lid member opens and closes, and dual speakers for playing audio, wherein one speaker is located on each side of the housing unit. The electric motor, control arm and plurality of wheels are attached to the housing unit.

### FIELD OF THE INVENTION

Embodiments described herein generally relate to coolers, and more particularly to a multi-functional electric cooler.

### BACKGROUND OF THE INVENTION

Oftentimes when visiting a beach an individual will bring a cooler to store beverages, food and other items. Presently, coolers are transported manually from one place to another. Depending on the weight of the cooler and the items contained therein, manually transporting a cooler can be an overwhelming task. In fact, the joy and contentment of visiting the beach can be ruined by having to lug a heavy cooler everywhere which can be strenuous on the back and arms. Hence, it is desirable to provide a more effective cooler.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary view of a multi-functional electric cooler according to an embodiment of the present disclosure.

### SUMMARY OF THE INVENTION

Exemplary embodiments disclosed herein describe a multi-functional electric cooler apparatus. The cooler apparatus includes an electric motor; a control arm including a handlebar member for controlling braking and acceleration of the cooler, the handlebar member having a built-in grip mechanism wherein the speed of the cooler is adjusted based on the grip intensity of the handlebar member; a plurality of wheels for transporting the cooler, wherein the wheels are spherical wheels; a housing unit having an enclosed insulated container for providing a temperature controlled storage area, a lid member including a plurality of cup holders and a solar panel for providing power to the cooler, wherein the lid member opens and closes, and dual speakers for playing audio, wherein one speaker is located on each side of the housing unit, the housing unit having attached thereto the electric motor, control arm and plurality of wheels.

In some exemplary embodiments, the housing unit includes an umbrella holder for storing an umbrella.

In some exemplary embodiments, the housing unit includes a USB port.

In some exemplary embodiments, the housing unit includes a wall plug.

In some exemplary embodiments, the cooler apparatus includes a rechargeable battery for providing power to the cooler.

In some exemplary embodiments, the rechargeable battery is charged from solar power from the solar panel.

In some exemplary embodiments, the rechargeable battery is charged from a wall charger using a wall plug.

In some exemplary embodiments, braking of the cooler occurs upon releasement of the built-in grip mechanism in the handlebar.

In some exemplary embodiments, the plurality of wheels are off-road wheels.

In some exemplary embodiments, the spherical wheels provide 360 degrees of rotation.

In some exemplary embodiments, the built-in grip mechanism is a throttle grip.

In some exemplary embodiments, the handlebar member allows multi-directional pull to be more responsive to changes in direction.

In some exemplary embodiment, a remote control is used to control the direction and speed of the cooler.

In some exemplary embodiments, the cooler apparatus includes a plurality of light emitting diode (LED) headlights.

In some embodiments, the cooler apparatus includes Bluetooth capabilities for synching one or more devices

In some exemplary embodiments, the dual speakers emit music from the one or more synched devices.

### DETAILED DESCRIPTION

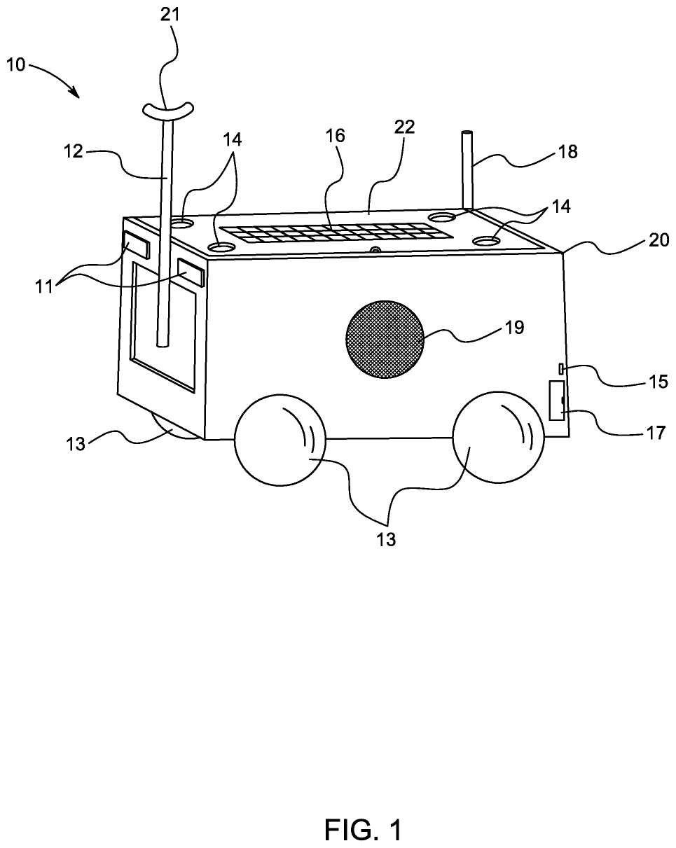

The present disclosure relates to an electric cooler apparatus with a variety of amenities. As illustrated in FIG. 1, the electric cooler apparatus 10 includes a pair of light emitting diode (“LED”) headlights 11, a control arm 12, a plurality of wheels 13, a plurality of cup holders 14, a USB port 15, a solar panel 16, a wall plug 17, an umbrella holder 18, a pair of speakers 19, a housing unit 20, Bluetooth technology (not shown), a motor (not shown) and a rechargeable battery (not shown).

The electric cooler apparatus 10 includes a motor which controls the turning motion of the wheels 13. The motor is powered by electricity from the solar panel 16 and/or the rechargeable battery. The rechargeable battery provides electricity to the electric cooler apparatus and may be charged from solar panel 16, wall charger/wall plug 17 or a power source attached to the USB port 15.

The control arm 12 includes a handlebar member 21 for controlling the acceleration and braking of the electric cooler apparatus 10. The handlebar member may include a built-in gripping mechanism, such as, for example, a throttle grip that controls the speed of the electric cooler apparatus 10. The speed of the electric cooler 10 is adjusted based on the grip intensity of the handlebar member. The gripping mechanism operates such that the harder the gripping mechanism is gripped, the faster the cooler apparatus goes, and upon release of the gripping mechanism, braking of the cooler apparatus occurs. In another exemplary embodiment, the handlebar member allows multi-directional pull to be more responsive to changes in direction. The control arm may be made out of any suitable material.

In an alternative embodiment, the direction and speed of the electric cooler apparatus 10 is controlled by a hand held device (not shown). The hand held device allows an individual to operate the cooler direction and speed without moving from his/her seat. In a preferred embodiment, the hand held device is a remote control.

The electric cooler apparatus 10 includes a dual pair of wheels 13. A set of two wheels is located on each side of the cooler apparatus. The wheels may each be plastic and ball-like. The plurality of wheels are off-road wheels. In a preferred embodiment, the plurality of wheels are spherical wheels each having 360 degrees of rotation.

The housing unit 20 includes an internal insulated container for providing a temperature controlled storage area. Ice can be used in the insulated container to cool the contents of the container. The housing unit includes a lid member 22, LED headlights 11, a USB port 15, a wall plug 17, a pair of speakers 19, and an umbrella holder 18. The lid member 22 opens and closes and includes a plurality of cup holders 14 and a solar panel 16. The solar panel powers the electric cooler apparatus 10. The housing unit may be made of any suitable material, such as, for example, plastic.

The LED headlights 11 are LED lamps or light bulbs for use in light fixtures that produces light using light-emitting diode (LED). The LED headlights may be located at the front of the cooler apparatus, the back of the cooler apparatus or both. Although the disclosure describes a pair of LED headlights, any number of LED headlights may be used. In another exemplary embodiment, the electric cooler includes a reflector in the back of the cooler apparatus or a real functioning brake light to add a safety element.

The electric cooler apparatus 10 includes Bluetooth capabilities which allows the cooler apparatus to synch with other devices having Bluetooth capabilities. In an exemplary embodiment, the pair of speakers 19 emit music from one or more synched devices, such as, for example, smart phones. The pair of speakers can be any type of suitable speakers.

The umbrella holder 18 is a circular shape tube-like structure with an open interior to store an umbrella, such as, for example, a beach umbrella.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A multi-functional electric cooler apparatus comprising:
an electric motor;
a control arm;
a handlebar member attached perpendicularly to a top end of the control arm, the handle bar member for controlling braking and acceleration of the cooler, the handlebar member having a built-in grip mechanism wherein the speed of the cooler is adjusted based on the grip intensity of the handlebar member, and wherein braking of the cooler occurs upon releasement of the built-in grip mechanism in the handlebar;
a dual pair of wheels, each pair located at opposite sides of a housing unit, the dual pair of wheels for transporting the cooler, wherein each wheel is a spherical wheel;
a housing unit having an enclosed insulated container for providing a temperature controlled storage area, a lid member including a plurality of cup holders; and
a solar panel for providing power to the cooler, wherein the lid member opens and closes, and dual speakers for playing audio, wherein one speaker is located on each side of the housing unit, the housing unit having attached thereto the electric motor, control arm and plurality of wheels.

2. The apparatus of claim 1, wherein the housing unit includes an umbrella holder for storing an umbrella.

3. The apparatus of claim 1, wherein the housing unit includes a USB port.

4. The apparatus of claim 1, wherein the housing unit includes a wall plug.

5. The apparatus of claim 1, wherein the cooler further comprises a rechargeable battery for providing power to the cooler.

6. The apparatus of claim 5, wherein the rechargeable battery is charged from solar power from the solar panel.

7. The apparatus of claim 6, wherein the rechargeable battery is charged from wall charger using the wall plug.

8. (canceled)

9. The apparatus of claim 1, wherein the plurality of wheels are off-road wheels.

10. The apparatus of claim 1, wherein the spherical wheels provide 360 degrees of rotation.

11. The apparatus of claim 1, wherein the built-in grip mechanism is a throttle grip.

12. The apparatus of claim 1, wherein the handlebar member allows multi-directional pull to be more responsive to changes in direction.

13. The apparatus of claim 1, wherein a remote control is used to control the direction and speed of the cooler.

14. The apparatus of claim 1, wherein the cooler includes a plurality of light emitting diode (LED) headlights.

15. The apparatus of claim 1, wherein the cooler includes Bluetooth capabilities for synching one or more devices.

16. The apparatus of claim 15, wherein the dual speakers emit music from the one or more synched devices.
